(19) United States
(12) Patent Application Publication
(10) Pub. No.: US 2007/0143864 A1
(43) Pub. Date: Jun. 21, 2007

(54) Methods and apparatus for power source authentication

(75) Inventors: Joe Cabana, Centereach, NY (US); Christopher Paul, Bayport, NY (US); Kevin Cordes, Miller Place, NY (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/303,181

(22) Filed: Dec. 15, 2005

(51) Int. Cl. G06F 11/00

(52) U.S. Cl. 726/36

(57) ABSTRACT

A power source management system disposed within a device is configured to communicate with a power source and perform an authentication procedure to determine whether the power source is an approved power source. The authentication procedure may involve the use of a challenge-response procedure using keys resident in the device and the power source. If it is determined that the power source is not an approved power source, the power source management system prevents use of or disables certain functionality of the device.

### TECHNICAL FIELD

The present invention generally relates to the use of batteries and other such power sources and, more particularly, to systems and methods for preventing the use of unapproved power sources.

### BACKGROUND

Many devices, particularly those with critical power requirements, are designed to use a specific power source (e.g., batteries) manufactured by a designated, authorized battery manufacturer. Nevertheless, other parties may manufacture and market what are known as “cloned” batteries that may fit the intended device, but which are not authorized for use with that device.

The use of such cloned batteries poses two problems. First, when a cloned battery is used, and that battery does not work properly, this failure reflects poorly on the party that manufacturers the device in which the battery is used, even though that party does not control the quality of the cloned battery. Second, cloned batteries are undesirable because they may incorporate inferior materials, might not be manufactured to the same standards, and/or might not be subject to the same level of quality control. Furthermore, cloned batteries are generally not submitted for UL (Underwriters Laboratories) approval, as any economically practical design submitted for UL approval requires submission of all chargers designed for use with that battery, which would be impracticable. The lack of UL approval has significant insurance implications for the end-customer.

Accordingly, for these and other reasons, there is a need for systems and methods that help prevent the use of unapproved power sources.

### BRIEF SUMMARY

In accordance with one embodiment of the present invention, a battery management system (or “power source management system”) within a device is configured to communicate with a power source and perform an authentication procedure wherein the battery management system determines whether the power source is an approved power source. Approved power sources are preconfigured with an appropriate cryptographic key or keys. If the system determines that the power source is not an approved power source, it disables or otherwise limits use of the device. The authentication procedure involves, in the illustrated embodiment, the use of a challenge-response scheme, wherein the device generates a random number, sends it to the power source for encryption and response, then compares that response with a response generated by the device itself using the same device-resident key. In this way, the present invention helps prevent the use of unapproved batteries and/or power sources.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a battery authentication system in accordance with one embodiment of the present invention;

FIG. 2 is a battery authentication system in accordance with another embodiment of the present invention;

FIG. 3 is a battery authentication system in accordance with another embodiment of the present invention;

FIG. 4 is a battery authentication system in accordance with another embodiment of the present invention;

FIG. 5 is a battery authentication system in accordance with another embodiment of the present invention;

FIG. 6 is a battery authentication system in accordance with one embodiment of the present invention; and

FIG. 7 is flowchart depicting an authentication procedure in accordance with one embodiment of the present invention.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description. In addition, the invention may be described in terms of functional and/or logical block components and various processing steps. It should be appreciated that such block components may be realized by any number of hardware, software, and/or firmware components configured to perform the specified functions.

In general, a power source management system in accordance with the present invention is configured to communicate with a power source and perform an authentication procedure wherein the power source management system determines whether the power source is an approved power source—i.e., a power source preconfigured with an appropriate cryptographic key or keys. In this regard, the terms “battery” and “power source” are often used interchangeably, and thus the term “battery” is not intended as a limitation of the present invention. If the system determines that the battery is not an approved power source, it disables or otherwise limits use of the device. The authentication procedure involves, in the illustrated embodiment, the use of a challenge-response scheme, wherein the device generates a random number, sends it to the battery for encryption and response, then compares that response with a response generated by the device itself using a device-resident key. The invention is not limited to challenge/response authentication, however, and encompasses any convenient authentication procedure.

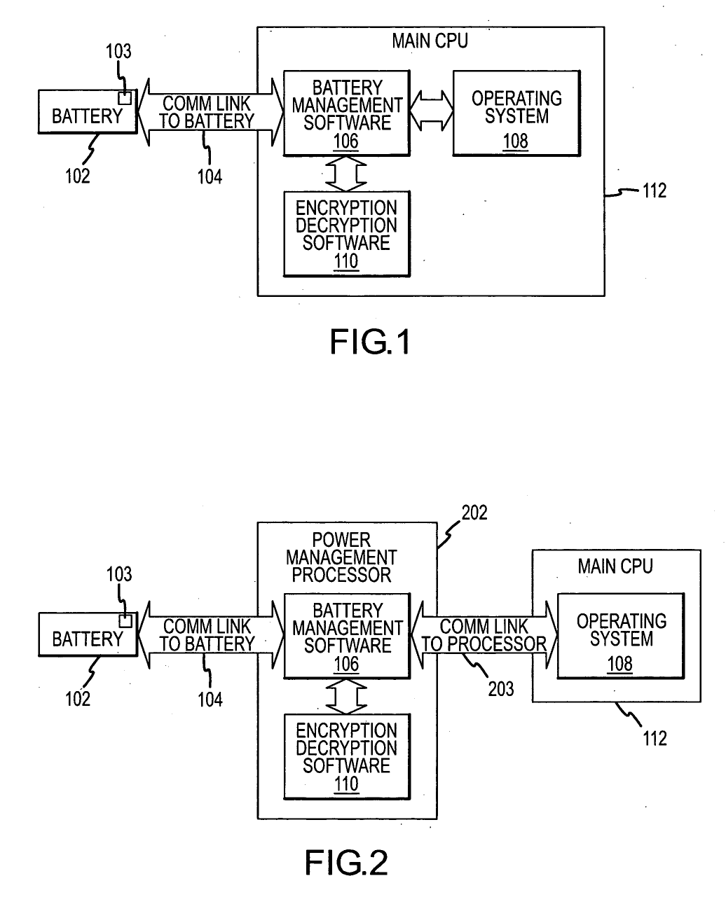

Referring to FIG. 1, a battery authentication system in accordance with one embodiment of the present invention generally includes a CPU 112, a battery management system 106, an operating system 108, and an encryption/decryption system 110. Battery management system 106 communicates with a battery logic subsystem 103 of battery 102 via a communication link 104, and is configured to communicate with a battery and perform an authentication procedure wherein the battery management system determines whether the battery is an approved power source. Approved power sources are preferably pre-configured with an appropriate cryptographic key or keys (e.g., within battery logic subsystem 103). If the system determines that the battery is not an approved power source, it disables or otherwise limits use of the device.

Battery 102 comprises any power source now known or later developed, including various primary and secondary batteries, fuel cells, and any other portable power source. It also includes various non-portable power sources such as AC adaptors, power supplies, etc. Battery logic subsystem 103 disposed within battery 102 includes suitable hardware and/or software (e.g., microcontrollers, memory devices, etc.) capable of performing the functions described herein.

CPU 112 refers to the CPU of a computer, terminal, portable bar-code reader, personal data assistant, cellular telephone, or any other type of device. Software implementations executed by CPU 112 (or a separate power management processor, as described below) may be implemented using any suitable software code now known or later developed, including, for example, assembly language, C, or the like.

Communication link 104 includes any convenient connection between the battery and CPU, and may implement any suitable protocol or communication method. In one embodiment, communication takes place through the terminal electrodes. Suitable connection systems include, for example, I2C, Dallas 1 Wire, and SMBUS.

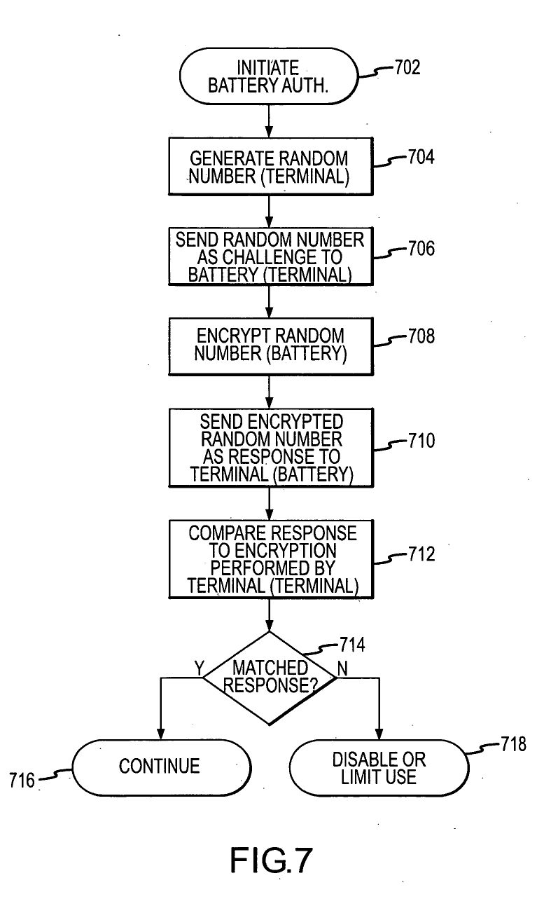

Having thus given an overview of one embodiment of the present invention, an exemplary method for battery authorization will now be described. As shown in FIG. 7, the system begins by initiating battery authorization (702). Initiation may take place, for example, when the battery is first inserted, or may take place at any arbitrary or scheduled time during which the battery is connected to the system.

Next, in step 704, the terminal (i.e., battery management software 106 implemented within a computer terminal or the like) generates a random number. The length of this random number may be selected depending upon the desired level of security in accordance with known cryptographic principles. The generated random number is then transmitted from the terminal to the battery as a challenge (step 706).

The battery encrypts the received random number (step 708) and sends the encrypted random number back to the terminal as a response to the challenge (step 710). This encryption may be private key, public/private key, or any other encryption algorithm.

The terminal then compares the response generated by the battery with the expected response (step 712). That is, the terminal performs its own encryption operation on the generated random number, and it is this number that the terminal compares with the battery's response. In one embodiment, the SHA-1/HMAC algorithm as employed in the Texas Instruments BQ26100 Integrated Circuit is used for encryption.

If the battery's response matches the expected response, then the battery is successfully authenticated and normal operation of the terminal can proceed (step 716). If, on the other hand, the battery is not successfully authenticated, then use of the terminal is disabled or otherwise limited (step 718). For example, the terminal may stop reporting battery charge level, disable recharging of the battery, disable use of certain functionality, reduce input/output capabilities, and/or disable use of the display.

Further details regarding authentication protocols and other such matters may be found in a number of standard reference books, including, for example, Bruce Schneier, Applied Cryptography, 2d ed. (1996).

In an alternate embodiment, a dedicated power management system is used. That is, referring to FIG. 1, the challenge-response of the illustrated embodiment is generated by the main CPU of the terminal. In FIG. 2, however, the challenge and response is generated by a dedicated power management processor 202. Power management processor 202 includes encryption/decryption software 110 and battery management software 106, which communicates with main CPU 112 through a second communication link 203.

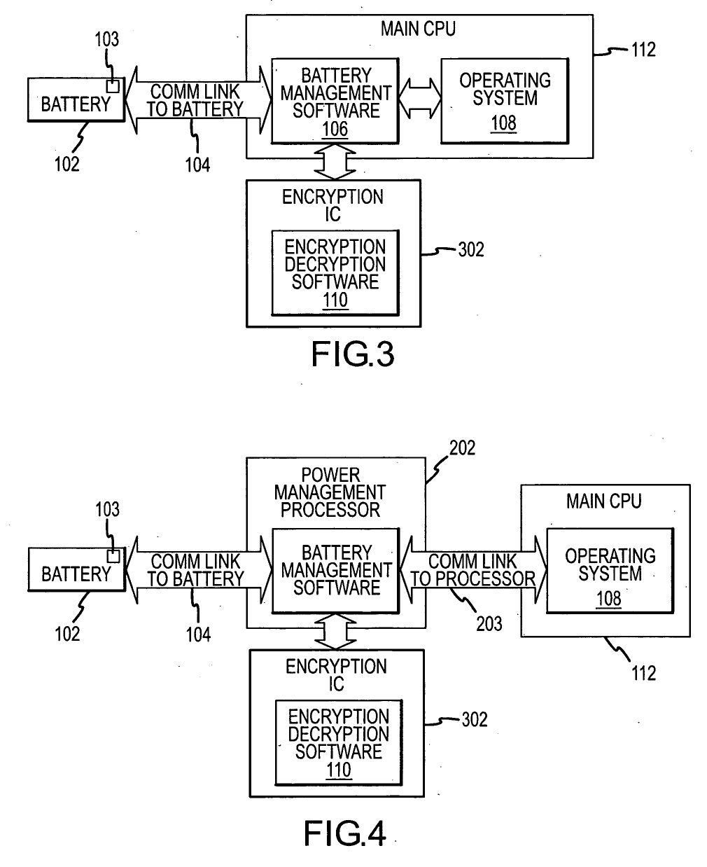

In another embodiment, shown in FIG. 3, a separate secure IC 302 generates the challenge and checks the response via an interface with battery management software 106. A combination of these two embodiments is shown in FIG. 4, in which a separate encryption IC is used in connection with a dedicated power management processor 202.

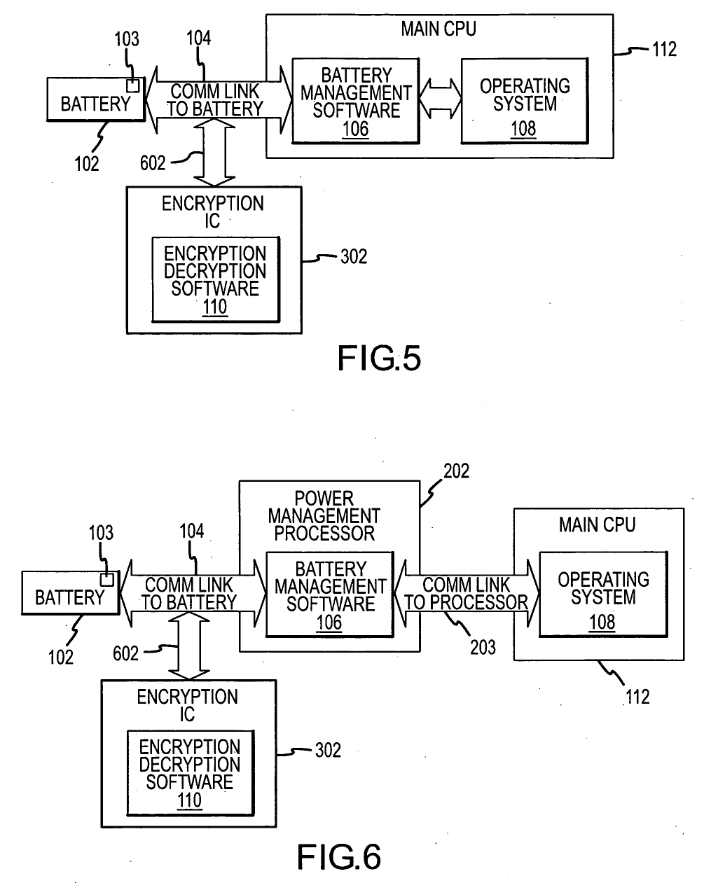

When a separate IC 302 is used to handle the encryption/decryption process (as in FIGS. 3 and 4), the system can be made more secure by allowing IC 302 to monitor the communication between battery 102 and the main CPU 112 or power management processor 202. The IC can then interrupt battery communications if it detects that the system is using a non-approved battery. Such embodiments are shown in FIGS. 5 and 6.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method of preventing the use of an inappropriate power source in conjunction with a device, said method comprising the steps of:
performing an authentication procedure wherein the device determines whether the power source is an approved power source;
reducing a functionality of the device in the event that said authentication procedure determines that the power source is not an approved power source.

2. The method of claim 1, wherein said step of reducing said functionality includes disabling operation of the device.

3. The method of claim 1, wherein said step of reducing said functionality includes limiting operation of the device.

4. The method of claim 1, wherein said authentication procedure includes a challenge-response procedure.

5. The method of claim 1, wherein said challenge-response procedure includes the steps of:
generating, at the device, a random number;
transmitting said random number to the power source;
encrypting, at the power source, said random number to produce a first encrypted value;
encrypting, at the device, said random number to produce a second encrypted value;
transmitting said first encrypted value to the device;
comparing, at the device, said first and second encrypted values.

6. The method of claim 5, wherein said first encrypted value is encrypted based on a key resident within said power source.

7. The method of claim 5, wherein said second encrypted value is encrypted based on a key resident within said device.

8. A power source management system disposed within a device, said power source management system configured to communicate with a power source and perform an authentication procedure wherein the power source management system determines whether said power source is an approved power source and prevents full operation of said device in the event that said authentication procedure determines that the power source is not an approved power source.

9. The system of claim 8, wherein said authentication procedure includes a challenge-response procedure.

10. The system of claim 9, wherein said challenge-response procedure includes the steps of:
generating a random number;
transmitting said random number to said power source;
receiving, from said power source, a first encrypted value;
encrypting said random number to produce a second encrypted value; and
comparing said first and second encrypted values.

11. The system of claim 10, wherein said second encrypted value is based on a key resident within said device.

12. The system of claim 8, wherein said power source management system is disposed within a CPU of said device.

13. The system of claim 8, wherein said power source management system is disposed within a power management processor that is external to a CPU of said device.

14. The system of claim 8, wherein the power source management system communicates with an external encryption IC.

15. The system of claim 14, wherein said external encryption IC monitors communication from said power source to said power source management system.

16. A power source comprising:
a processor;
a memory coupled to said processor;
a communication link coupled to said processor, wherein said processor is configured to receive a challenge number via said communication link, encrypt said challenge number utilizing a key resident in said memory to form a response, and transmit said response via said communication link.
